(19) United States
(12) Patent Application Publication
(10) Pub. No.: US 2018/0029063 A1
(43) Pub. Date: Feb. 1, 2018

(54) COATING DEVICE COMPRISING AN ADJUSTABLE TEAR-OFF EDGE

(71) Applicant: JOSEF SCHIELE OHG, Niederzissen (DE)

(72) Inventor: Stefan Schiele, Niederzissen (DE)

(21) Appl. No.: 15/554,837

(22) PCT Filed: Mar. 1, 2016
(86) PCT No.: PCT/EP2016/054314

§ 371 Date: Aug. 31, 2017

(30) Foreign Application Priority Data
Mar. 3, 2015 (DE) 10 2015 203 809.2

(51) Int. Cl. B05B 15/04; B05D 1/02; B05B 13/02

(52) U.S. Cl. CPC B05B 15/0437; B05B 13/0207; B05D 1/02

(57) ABSTRACT

The invention relates to a coating device (1) comprising a coating chamber (17), in which at least one coating agent (2) is provided, which applies a coating to the coating surface (15) of a workpiece, which moves through the coating chamber in a transport direction (x), wherein in the coating chamber (17) a negative pressure is applied and the coating surface is delimited by at least one tool (6, 7) comprising a tear-off edge and the coating chamber (17) is delimited by an inlet die and and outlet die (11). The present invention further relates to a method for coating the coating surface (15) of a workpiece with a coating agent (2), wherein the coating surface is delimited by at least one tool (6, 7) with a tear-off edge (18).

The invention relates to a coating device having a coating chamber in which there is provided at least one coating means which applies a coating to the coating surface of a workpiece which moves through the coating chamber along a transport direction, wherein a negative pressure prevails in the coating chamber, and the coating surface is delimited by at least one tool having a separation edge, and the coating chamber is delimited by an inlet die and an outlet die. Furthermore, the present invention relates to a method for coating the coating surface of a workpiece with a coating means, wherein the coating surface is delimited by at least one tool having a separation edge.

Coating devices of said type are known from the prior art and are used in particular for coating elongate profiles, such as for example window profiles. Here, it is possible to provide, a seal or the like in a materially joined manner on the profile, which consists for example of plastic, metal and/or wood, for example by way of extrusion on said profile. At the coating device, the workpiece is transported through a coating chamber, and in the process a coating surface is provided with a coating by a coating means, for example by a spray nozzle. In order to limit the coating to the coating surface, the coating chamber according to the invention has at least one tool. At the coating device, the coating chamber is subjected to a negative pressure in order to extract excess coating material from the coating surface by suction and/or to prevent the coating being carried cut beyond the desired coating surface.

However, the coating devices according to the prior art have the disadvantage that only with considerable effort is it possible to newly set or adapt them to new profiles or during the coating.

It was therefore the object of the present invention to provide a coating device which does not have the disadvantages of the prior art.

The object is achieved by way of a coating device having a coating chamber in which there is provided at least one coating means which applies a coating to the coating surface of a workpiece which moves through the coating chamber along a transport direction, wherein a negative pressure prevails in the coating chamber, and the coating surface is delimited by at least one tool having a separation edge, and the coating chamber is delimited by an inlet die and an outlet die, wherein the tool is mounted outside the costing chamber.

The present invention relates to a coating device having a coating chamber in which there is provided at least one coating means which applies the coating to the coating surface of a workpiece which moves through the coating chamber along a transport direction, wherein a negative pressure prevails in the coating chamber. The workpiece is generally an elongate profile, for example part of the frame of a window or a flooring, and is produced in particular from plastic, metal and/or wood. It is possible to provide on the profile, in particular in a materially joined manner, a seal which is preferably at least partially coated along therewith. Such coating devices are sold for example by the present applicant under the trade name Vacumat®. The coating surface is delimited by at least one tool which has a separation edge, and the coating chamber has an inlet die and an outlet die. The workpiece to be coated enters the coating chamber through the inlet die and is provided there with the coating material and then exits the coating chamber through the outlet die. As a result of the negative pressure present in the coating chamber, firstly the coating on the desired coating surface is reduced, and secondly excessively applied coating means is removed from the workpiece again. Due to the negative pressure, air is drawn in from outside, in particular through the inlet die and/or the outlet die, this air being used to remove the excessively applied coating means and so-called overspray from the coating chamber. Preferably, more air is drawn in through the outlet die than through the inlet die. The air stream in the coating chamber gives rise also to an air stream between the workpiece and the separation edge of the tool, which results in a clean boundary line up to which the coating of the workpiece is carried out. The mixture of coating means and air is preferably guided via a filter system in which the coating means is separated away from the air and if appropriate returned to the coating process.

According to the invention, it is now provided that the tool having the separation edge is mounted outside the coating chamber. This makes it possible for the tool to be adapted to a new profile by adjustment of the mounting of said tool, or for the tool and thus the separation edge to be realigned, without having to reach into the coating chamber. This makes the setting or adjustment process considerably quicker and easier. In particular, the setting can also take place during the coating if the coating result does not correspond to the desired specifications, in particular if a coating is carried out beyond the desired coating surface. The extent of the tool parallel to the transport direction of the workpiece is here at least as long as, preferably longer than, the extent of the coating chamber parallel to the transport direction of the workpiece.

The device according to the invention allows workpieces to be partially coated. In the case of workpieces having a seal, it is also possible for the seal to be fully or partially coated. The workpiece and/or the seal may in this case have undercuts which are optionally coated.

According to a further preferred or inventive subject of the present invention, the tool having the separation edge is connected outside the coating chamber to an adjustment means. Preferably said adjustment means is a so-called XY adjustment means, so that the separation edge can be set in two spatial directions, in particular separately from one another. The two spatial directions are in this case preferably provided at an angle of 90° to one another. Here, the adjustment of the tool can be carried out by motor drive and/or manually.

Preferably, an air stream forms between the tool and the workpiece at least partially and/or at least temporarily, preferably during the entire coating operation, which air stream is induced by the negative pressure present in the coating chamber and preferably flows at least partially along the tool and particularly preferably separates at the separation edge. Said air stream in particular prevents the coating means advancing beyond the tool and thereby enlarging the coating surface in an undesired manner. The air stream between the tool and the workpiece results in a clear line up to which the coating is carried out.

Preferably, provision is made in the coating chamber for a covering mask which has a preferably settable element, wherein between said element and the tool having the separation edge there is provided a gap whose size is formed so as to be adjustable, preferably by adjustment of the tool and/or by adjustment of the settable element. 35 Particularly preferably, a negative pressure prevails at the gap such that an air stream is established in the gap. By setting the gap, advancement of the coating beyond the desired coating surface is preferably prevented.

According to a preferred embodiment of the present invention, the coating device has two tools, with in each case one separation edge, which are settable in at least one, preferably two, spatial directions, independently of one another, said directions preferably being provided at an angle of 90° to one another.

Preferably, each tool having the separation edge is set during the coating operation.

A further subject of the present invention is a method for coating the coating surface of a workpiece with a coating means, wherein the coating surface is delimited by at least one tool having a separation edge, and in which the tool is settable in at least one, preferably two, spatial directions during the coating and/or outside the coating chamber.

The statements made with respect to this subject of the present invention apply equally to the coating device according to the invention, and vice versa.

Preferably, an air stream forms between the workpiece and the separation edge.

Preferably, the setting of the position of each tool having the separation edge is carried out automatically. For this purpose, a sensor means, for example a camera, which registers for example the coating result achieved and, in the event of insufficient coating, performs a setting at the tool having the separation edge, is particularly preferably provided.

The invention will now be explained on the basis of the figures. Said explanations are merely exemplary and do not restrict the general concepts of the invention. The explanations apply equally to all subjects of the present inventions.

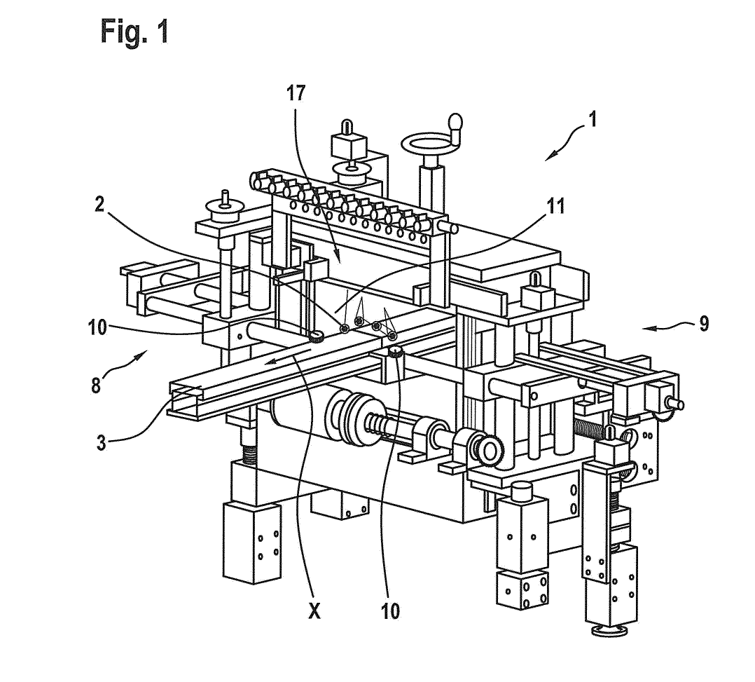

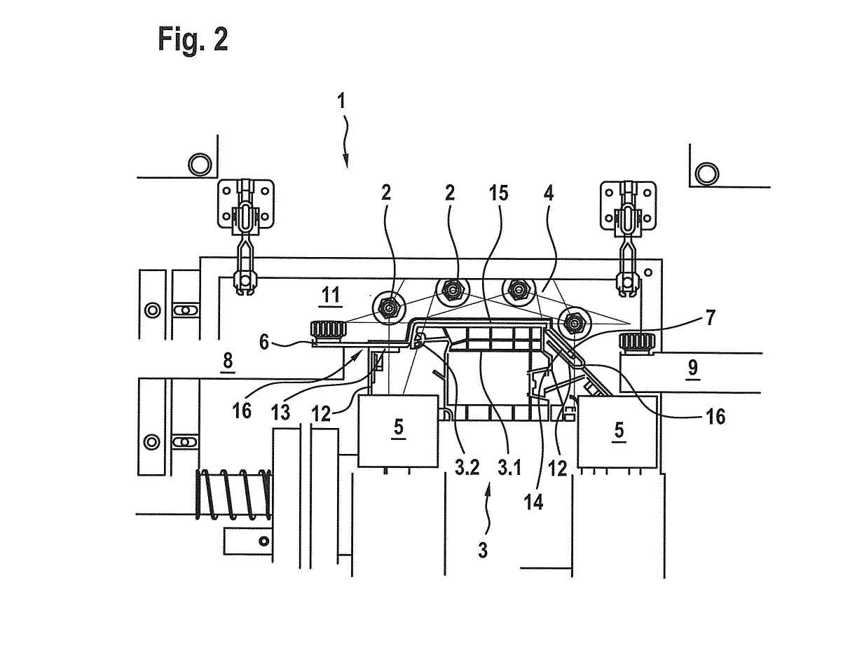

FIGS. 1 and 2 show the coating device according to the invention.

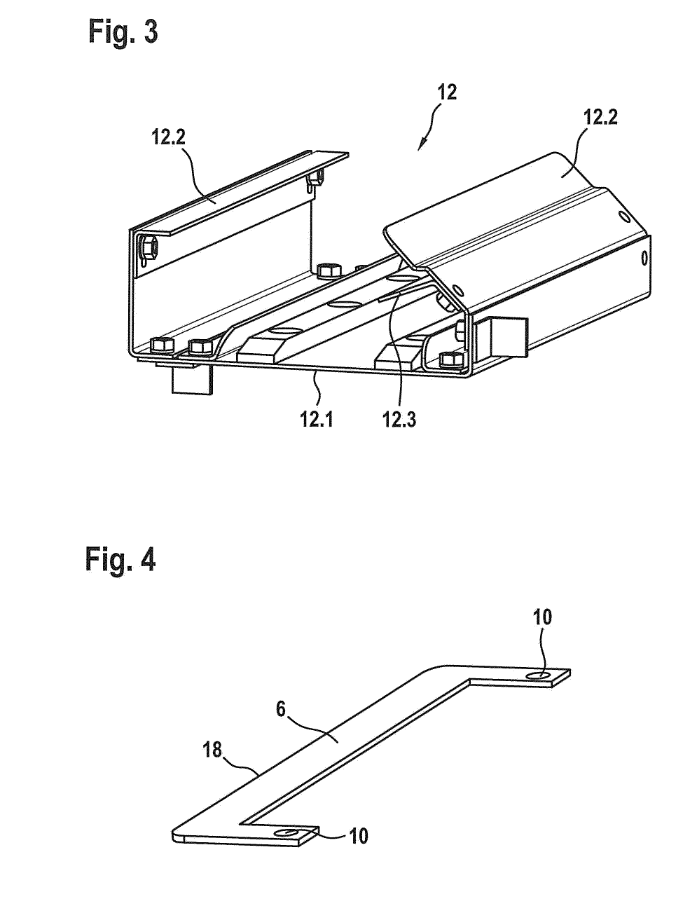

FIG. 3 shows the covering mask.

FIG. 4 shows a tool having a separation edge.

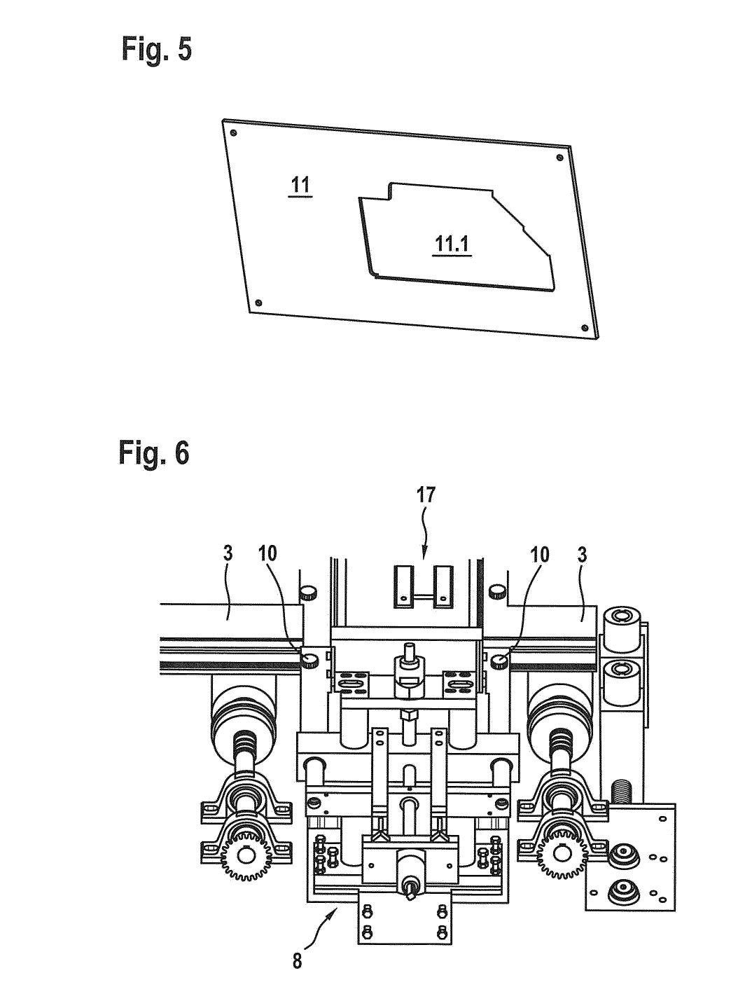

FIG. 5 shows the inlet die or outlet die.

FIG. 6 shows further details of the coating device according to FIGS. 1 and 2.

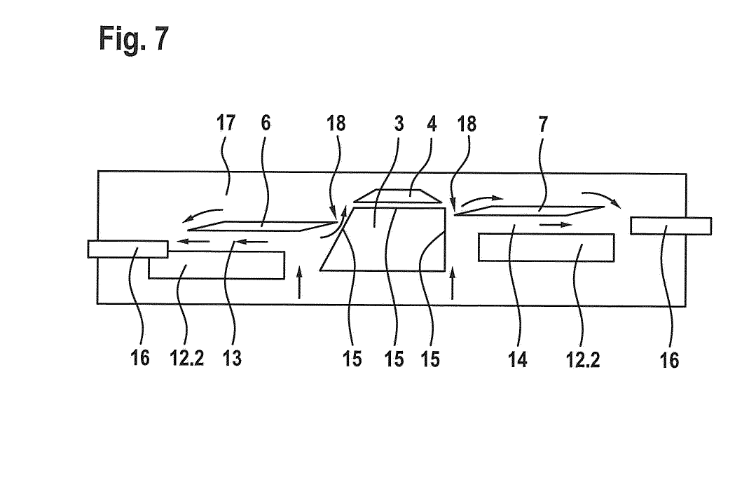

FIG. 7 schematically shows the coating chamber.

FIGS. 1 and 2 show the coating: device 1 according to the invention which has a coating chamber 17 in which a workpiece 3 is coated on a coating surface along the main direction of extent of said workpiece through the chamber. The transport direction of the workpiece is provided with the reference sign x. For this purpose, the coating device has one or more coating means 2, for example spray nozzles, which apply a coating material, in particular a paint, particularly preferably a water-soluble paint, to the surface 15 to be coated. Since in general only a limited portion of the workpiece is to be coated, the device according to the invention has two-tools 6, 7, with in each case one separation edge 18, which delimit the coating surface. The workpiece 3 enters through an inlet die which preferably substantially follows the outer cross-sectional contour of the workpiece, is coated in the coating chamber, and exits the coating chamber through an outlet die which preferably has the same or a larger opening for the exiting workpiece as/than the inlet die. The coating chamber 17 is subjected to a certain negative pressure such that air is drawn in from outside through the inlet die and the outlet die, this air being used to remove excessively applied coating means from the workpiece again and if appropriate to carry any overspray present out of the coating chamber. The mixture of air and coating means is then preferably moved via a filter system in which the coating means is removed from the air and the separated coating means is, if appropriate, returned to the coating process. According to the invention, the tool 6, 7 and thus the separation edge 18 then extends beyond the longitudinal extent of the coating chamber, that is to say it projects out of the inlet die or outlet die on one side, preferably both sides, where it is mounted, preferably with connection means 10, on an adjustment means 8,9 with which it is possible to adjust the separation edge 18 at least in one, preferably in two, spatial directions in a linear and/or rotational manner. By virtue of the fact that the tool 6, 7 having the separation edge 18 is suspended outside the coating chamber, it is easily possible to set said tool prior to start-up and/or during the coating, without there being a need to reach into the coating chamber 17. It is thus possible in a simple manner for the separation edge 18 to be set to a profile to be newly coated, and/or to be adapted to tolerances of the profile to be coated which arise, and/or for the separation edge to be readjusted in the case of changing coating parameters and/or a varying coating result. Here, the adjustment of the separation edge can take place both manually and by motor drive. As can foe seen in particular in FIG. 2, the coating device according to the invention has a guide 5, here two guide rolls, which guide the workpiece prior to the entry into the coating chamber and/or following the exit from the coating chamber. Preferably, the guides are provided such that they stabilize the workpiece in two spatial directions. However, it is also possible to provide two guide rolls which guide the workpiece in a horizontal direction and a hold-down device 12.3 which guides the workpiece in the vertical direction. In the present case, the workpiece 3 is a window profile which is produced from a plastic, metal and/or wood and onto which, in the present case, a seal 3.2 is arranged in a materially joined manner, in particular by way of extrusion on said profile. The tool 6 having the separation edge 18 interacts in the present case with the seal 3.2 and prevents this being fully coated with the coating material. The tool 7 having the separation edge 18 interacts with the bearing part 3.1, here a plastic part, and likewise prevents this being fully coated. Provided in the coating chamber 17 is a covering mask 12 which will be explained in more detail on the basis of FIG. 3. As can likewise be seen in FIG. 2, a first or a second gap 13, 14 is provided between the covering mask 12 and the respective tool 6, 7. Said gap is connected to a negative-pressure channel 16 such that drawn-in air flows through said gap. The separation edge can be adjusted or set due to the gap 13, 14. Likewise indicated in FIG. 2 are the adjustment means 8, 9 which are situated in front of the inlet die or outlet die 11 and are thus not arranged in the costing chamber.

FIG. 3 shows the covering mask 12 which is provided completely in the coating chamber and consists of a base element 12.1 on which at least one, here two, settable elements 12.2 are provided. Preferably, each settable element 12.2 is provided, at least in sections, parallel to the associated separation edge 6, 7. The size of the gap 13, 14 between the covering mask and the respective separation die 6, 7, and thus the size of the air stream in said gap, may be set by way of the settable element 12.2. The size of the gap 13, 14 may alternatively or additionally also be varied by an adjustment of the tool 6, 7. In the present case, the covering mask also has a hold-down device 12.3 which prevents the workpiece to be coated from moving in an unwanted manner in the vertical direction, in particular against the force of gravity. Consequently, the horizontal guide may be designed as two rolls having a vertical axis of rotation. The covering mask 12 is at least substantially independent of the profile to be coated, that is to say may be used universally. It is inserted into, preferally pushed into, the coating chamber, in particular on the inlet side.

FIG. 4 shows by way of example a tool 6 having a separation edge 18. In the present case, the tool is provided in a U-shape, wherein the bass of the U-shape, in particular the tip thereof, forms the separation edge 18 and interacts with the workpiece, here the seal 3.2, and consequently delimits the coating surface. Each connection means 10 which connects the tool 6, 7 to an adjustment means 8, 9 is in each case situated outside the coating chamber 17.

FIG. 5 shows by way of example the inlet die or the outlet die 11 which delimits the coating chamber 17 on its front side or rear side, respectively. The die 11 has a cutout 11.1 through which workpiece enters the coating chamber 17, or through which the workpiece 3 exits the coating chamber. In this case, the contour of the cutout 11.1 preferably follows the cross-sectional area perpendicular to the transport direction x of the workpiece to be coated.

FIG. 6 shows further details of the coating device according to the invention. The workpiece 3 is guided through the coating chamber 17 from right to left. It can be clearly be seen that the connection means 10 on which the separation edge (not illustrated) is suspended is in each case located to the right and to the left of the coating chamber, that is to say is not provided in the coating chamber 17. It can furthermore be seen that the connection means 10 are provided at an adjustment means, here an XY adjustment means 8, with which the tools 6, 7 is provided so as to be adjustable in two spatial directions.

FIG. 7 schematically shows the coating chamber 17 in which there is provided a costing means (not illustrated) which produces a spray cone 4 with which the coating surface 15 of the workpiece 3 is coated. The coating surface 15 is delimited by the separation edges 18 of the tools 6, 7, which edges, in the present case, are situated on the right and on the left with respect to the transport direction of the workpiece 3 (here into the paper plane). According to the invention, the position of the tools 6, 7 and thus the separation edges 18 can be adjusted in order not only to limit the coating surface 15 to the desired dimension, but also it appropriate to produce a specific gap between the separation edge and the workpiece. The settable element 12.2 of the covering mask 12 and the vacuum means 16 is also illustrated schematically. Provided between the settable element 12.2 and the respective separation edge 6, 7 is a gap through which there is an air stream due to the negative pressure generated by the vacuum source 16. Furthermore, the vacuum source 16 ensures an air stream between the separation edge and the workpiece 3, as a result of which unwanted extension of the coating surface is prevented. In order to be able to set separation edge 18 to the tolerances of the workpieces to be coated, each tool 6, 7 should have a correspondingly large movement range. This can be achieved due to the air gap between the tool 6, 7 and the parallel element 12.2. Due to the prevailing vacuum, external, air is drawn in through the gap 12, 14, and the passing of paint material beneath the settable tools 6, 7 onto those regions of the workpiece 3 which are not to be coated is prevented.

### LIST OF REFERENCE SIGNS

1 Coating device

2 Coating means, spray nozzles

3 Workpiece

3.1 Bearing part, plastic part

3.2 Seal

4 Spray cone

5 Guide

6 First set table tool

7 Second settable tool

8 First adjustment means, X-Y adjustment means

9 Second adjustment means, X-Y adjustment means

10 Connection means between adjustment means 8, 9 and separation edge 6, 7

11 Inlet die, outlet die

11.1 Cutout for the workpiece

12 Covering mask

12.1 Base element

12.2 Settable element

12.3 Hold-down device

13 First gap

14 Second gap

15 Coating edge, coating surface

16 Vacuum channel.

17 Coating chamber

18 Separation edge

X Transport direction

1. A coating device having a coating chamber in which there is provided at least one coating means which applies a coating to a coating surface of a workpiece which moves through the coating chamber along a transport direction, wherein a negative pressure prevails in the coating chamber, and the coating surface is delimited by at least one tool having a separation edge, and the coating chamber is delimited by an inlet die and an outlet die, wherein the at least one tool mounted outside the coating chamber, wherein the negative pressure between the separation edge of the at least one tool and the workpiece at least temporarily forms an air stream for the formation of a boundary line up to which the coating of the workpiece is carried out, wherein the air stream is provided such that it separates at the separation edge.

2. The coating device as claimed in claim 1, wherein each tool is connected outside the coating chamber to an adjustment means.

3. The coating device as claimed in claim 2, wherein the adjustment means is an XY adjustment means, so that the separation edge is settable in two spatial directions.

4. The coating device as claimed in claim 1, wherein the device has in the coating chamber a covering mask on which at least one element is provided, which element forms a gap between the element and each tool.

5. The coating device as claimed in claim 4, wherein a negative pressure prevails in the gap.

6. The coating device as claimed in claim 1, wherein only one tool which is settable in at least one spatial direction, independently of one another, is present.

7. The coating device as claimed in claim 1, wherein the device has two tools which are settable in at least one spatial direction, independently of one another.

8. The coating device as claimed in claim 1, wherein it is possible to set each tool during the coating process.

9. A method for coating a coating surface of a workpiece with a coating means, wherein the coating surface is delimited by at least one tool having a separation edge, wherein the tool is settable in at least one spatial direction during the coating and/or outside a coating chamber, wherein an air stream, which is induced by a negative pressure present in the coating chamber, is created between the workpiece and the tool, wherein the air stream separates at the separation edge.

10. The method as claimed in claim 9, wherein setting of the tool is carried out automatically.

11. The coating device as claimed in claim 3, wherein the separation edge is settable in two spatial directions separately from one another.

12. The coating device as claimed in claim 6, wherein only one tool, which is settable in two spatial directions, independently of one another, is present.

13. The coating device as claimed in claim 7, wherein the device has two tools, which are settable in two spatial directions, independently of one another.

14. The method of claim 9, wherein the tool is settable in two spatial directions during the coating and/or outside the coating chamber.
